(19) United States
(12) Patent Application Publication
(10) Pub. No.: US 2015/0035741 A1
(43) Pub. Date: Feb. 5, 2015

(54) DISPLAY APPARATUS

(71) Applicant: Samsung Display Co., Ltd., Yongin-City (KR)

(72) Inventors: Sunhwa Lee, Hwaseong-si (KR); Jae Hwa Park, Gumi-si (KR); Kwang-Chul Jung, Seongnam-si (KR); Kipyo Hong, Hwaseong-si (KR); Yong Seok Kim, Seoul (KR); Sunghwan Won, Suwon-si (KR); Meehye Jung, Suwon-si (KR)

(21) Appl. No.: 14/317,768

(22) Filed: Jun. 27, 2014

(30) Foreign Application Priority Data
Jul. 30, 2013 (KR) 10-2013-0090283
Jan. 9, 2014 (KR) 10-2014-0002953

(51) Int. Cl. G09G 3/36

(52) U.S. Cl. CPC G09G 3/3648
USPC 345/103

(57) ABSTRACT

A display apparatus includes a base substrate, an array of pixel electrodes formed over the base substrate, an array of active cavities disposed over the array of pixel electrodes, at least one common electrode opposing the array of pixel electrodes such that the array of active cavities are disposed between the at least one common electrode and the array of pixel electrodes. The apparatus further includes a metal line electrically connected with the at least one common electrode in the display area.

### CROSS-REFERENCE TO RELATED APPLICATION

This U.S. non-provisional patent application claims priority under 35 U.S.C. §119 of Korean Patent Applications Nos. 10-2013-0090283, filed on Jul. 30, 2013 and 10-2014-0002953, field on Jan. 9, 2014, the contents of which are hereby incorporated by reference in its entirety.

### BACKGROUND

1. Field of disclosure

The present disclosure relates to a display apparatus. More particularly, the present disclosure relates to a display apparatus having improved display quality.

2. Description of the Related Art

In recent years, various flat display apparatuses, such as a liquid crystal display, an electrophoretic display, etc., are widely used to replace a cathode-ray tube.

In general, the flat display apparatus includes two substrates and an image display layer interposed between the two substrates, e.g., a liquid crystal layer, an electrophoretic layer, etc. The two substrates are coupled to each other to face each other and spaced apart from each other such that the image display layer is disposed between the two substrates.

To manufacture the flat display apparatus, a process of forming a spacer on one substrate of the two substrates to maintain a distance between the two substrates and a process of attaching the spacer to the other substrate of the two substrates using adhesive are required.

Accordingly, a manufacturing process of the flat display apparatus becomes complicated and a manufacturing cost of the flat display apparatus increases.

### SUMMARY

The present disclosure provides a display apparatus capable of preventing a display quality from being degraded.

One aspect of the invention provides a display apparatus comprising: a base substrate; an array of pixel electrodes formed over the base substrate; an array of active cavities disposed over the array of pixel electrodes; at least one common electrode opposing the array of pixel electrodes such that the array of active cavities are disposed between the at least one common electrode and the array of pixel electrodes; a metal line electrically connected with the at least one common electrode in the display area.

Another aspect of the invention provides a display apparatus comprising: a base substrate including a display area and a peripheral area surrounding the display area; an array pixel electrodes formed over the display area of the base substrate, the pixel electrodes arranged in rows and columns; an array of active cavities, each of which is disposed over a corresponding one of the pixel electrodes; an array of common electrodes arranged in the rows and the columns such that each of the common electrodes opposes one of the array of pixel electrodes, wherein the array of active cavities are disposed between the array of common electrodes and the array of pixel electrodes; and a metal line electrically connected with two or more the common electrodes arranged in one of the rows or one of the columns in the display area.

According to the above, the common electrodes are electrically connected to the metal line, and thus the electric potential of the common electrode may be prevented from being lowered in the center portion of the display area, thereby preventing a crosstalk defect and improving a display quality.

In addition, since the common electrodes are arranged in the first and second directions and spaced apart from each other to have a dot shape, the coupling capacitor between the common electrodes and the data lines and between the common electrodes and the pixels electrodes may be reduced.

### BRIEF DESCRIPTION OF THE DRAWINGS

The above and other advantages of the present disclosure will become readily apparent by reference to the following detailed description when considered in conjunction with the accompanying drawings wherein:

FIG. 1 is a plan view showing a display apparatus according to an exemplary embodiment of the present disclosure;

FIG. 2 is a plan view showing a pixel shown in FIG. 1;

FIG. 3A is a cross-sectional view taken along a line I-I′ of FIG. 2;

FIG. 3B is a cross-sectional view taken along a line II-II′ of FIG. 2;

FIG. 3C is a cross-sectional view taken along a line of FIG. 2;

FIG. 4 is a plan view showing a display apparatus according to another exemplary embodiment of the present disclosure;

FIG. 5 is a plan view showing a pixel according to another exemplary embodiment of the present disclosure;

FIG. 6 is an enlarged view showing a portion A1 shown in FIG. 5;

FIG. 7A is a cross-sectional view taken along a line IV-IV′ shown in FIG. 5;

FIG. 7B is a cross-sectional view taken along a line V-V′ shown in FIG. 5;

FIG. 8 is a plan view showing a pixel according to another exemplary embodiment of the present disclosure;

FIG. 9 is a cross-sectional view taken along a line VI-VI′ shown in FIG. 8;

FIG. 10 is a plan view showing a display apparatus according to another exemplary embodiment of the present disclosure;

FIG. 11 is a plan view showing a display apparatus according to another exemplary embodiment of the present disclosure;

FIG. 12 is a plan view showing a pixel shown in FIG. 11;

FIG. 13 is a cross-sectional view taken along a line VII-VII′ shown in FIG. 12;

FIG. 14 is a plan view showing a display apparatus according to another exemplary embodiment of the present disclosure;

FIG. 15 is a cross-sectional view taken along a line shown in FIG. 14;

FIG. 16 is a plan view showing a common electrode according to another exemplary embodiment of the present disclosure;

FIG. 17 is a plan view showing two pixels according to an exemplary embodiment of the present disclosure;

FIG. 18 is a cross-sectional view taken along a line IX-IX′ shown in FIG. 17;

FIG. 19 is a plan view showing two pixels according to another exemplary embodiment of the present disclosure; and

FIG. 20 is a cross-sectional view taken along a line IX-IX′ shown in FIG. 19.

### DETAILED DESCRIPTION

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present invention will be explained in detail with reference to the accompanying drawings.

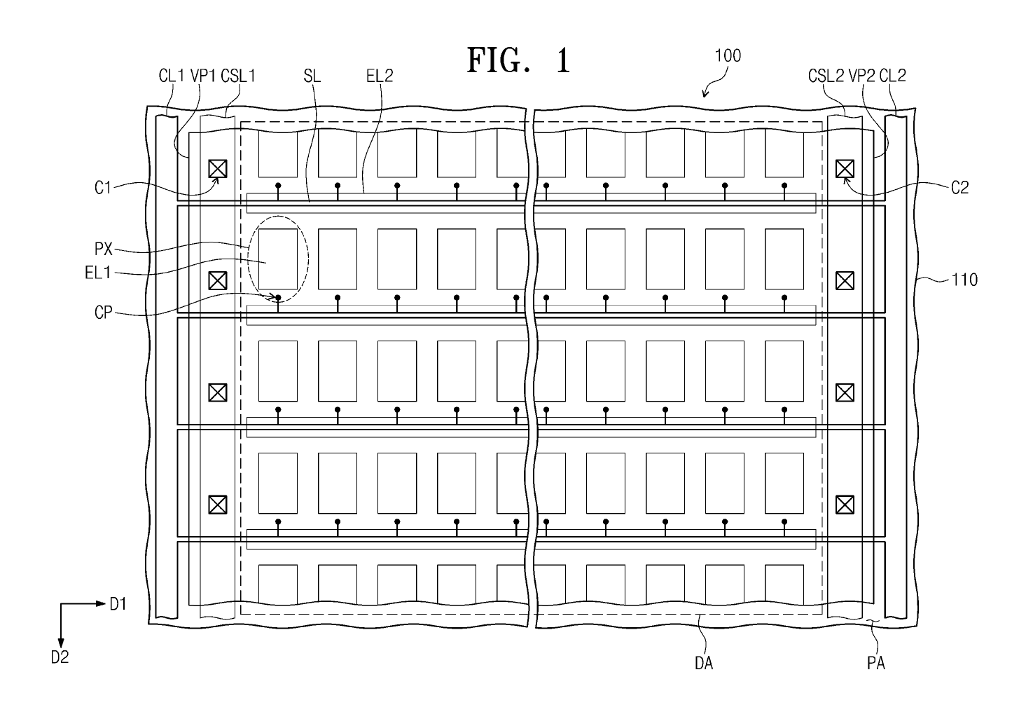

FIG. 1 is a plan view showing a display apparatus according to an exemplary embodiment of the present disclosure.

Referring to FIG. 1, a display apparatus 100 includes a base substrate 110 and a plurality of pixels PX arranged on the base substrate 110.

The base substrate 110 may be a transparent or non-transparent insulating substrate, e.g., a silicon substrate, a glass substrate, a plastic substrate, etc. The base substrate 110 includes a display area DA and a peripheral area PA. The display area DA includes the pixels PX to display an image. Each pixel PX includes a thin film transistor (not shown) and a pixel electrode EL1.

The peripheral area PA is disposed adjacent to at least one side or two sides, or disposed to surround the display area DA.

The pixels PX are arranged on the display area DA of the base substrate 110 in a matrix form of rows by columns. A plurality of gate lines (not shown) that applies a gate signal to the pixels PX and a plurality of data lines (not shown) that applies a data signal to the pixels PX are disposed on the base substrate 110. The gate lines extend in a first direction D1 in the display area DA and are arranged in a second direction D2 to be spaced apart from each other. The data lines extend in the second direction D2 in the display area DA and arranged in the first direction D1 to be spaced apart from each other. For the convenience of explanation, the gate lines and the data lines have been omitted in FIG. 1.

Storage lines SL are arranged in the display area DA along the gate lines. In detail, the storage lines SL extend in the first direction D1 and are arranged in the second direction D2 to be spaced apart from each other. First and second connection lines CL1 and CL2 are disposed in the peripheral area PA and extend in the second direction D2. The first and second connection lines CL1 and CL2 electrically connect the storage lines SL. In more detail, the first connection lines CL1 electrically connect one ends of the storage lines SL and the second connection lines CL2 electrically connect the other ends of the storage lines SL. In addition, the first and second connection lines CL1 and CL2 receive a storage voltage from an external source (not shown) and apply the storage voltage to the storage lines SL.

Common electrodes EL2 are further disposed in the display area DA of the base substrate 110. The common electrodes EL2 extend in the first direction D1 and are arranged in the second direction D2 in the display area DA. First and second vertical electrode parts VP1 and VP2 are further disposed in the peripheral area PA to electrically connect the common electrodes EL2. The first and second vertical electrode parts VP1 and VP2 respectively extend from both ends of the common electrodes EL2 and extend in the second direction D2 to allow the common electrodes EL2 to be electrically connected to each other.

First and second common voltage lines CSL1 and CSL2 are further disposed in the peripheral area PA to electrically make contact with the first and second vertical electrode parts VP1 and VP2. The first common voltage line CSL1 extends in the second direction D2 and electrically makes contact with the first vertical electrode part VP1 through a plurality of first contact holes C1. The second common voltage line CSL2 extends in the second direction D2 and electrically makes contact with the second vertical electrode part VP2 through a plurality of second contact holes C2.

Accordingly, the first and second common voltage lines CSL1 and CSL2 may apply the common voltage from the external source to the common electrodes EL2.

As shown in FIG. 1, each of the common electrodes EL2 is disposed in the display area DA to correspond to several pixel rows. However, the level of the common voltage applied to the common electrode EL2 becomes lower as a distance from a center portion DA decreases. The variation of the common voltage may be recognized as a crosstalk defect.

To settle this, each of the common electrodes EL2 is electrically connected to an adjacent metal line thereto. The metal line may be the storage line SL applied with the storage voltage. The storage voltage has the same electric potential as that of the common voltage. Therefore, each of the common electrodes EL2 receives the storage voltage through the adjacent storage line SL as the common voltage. In embodiments, the common electrode EL2 and the metal line are electrically connected to each other without any switching element, any transistor or any diode therebetween. In an embodiment, the common electrode EL2 and the metal line are electrically connected to each other without any semiconductor material therebetween. In another embodiment, the common electrode EL2 and the metal line are electrically connected to each other only with a conductive material or conductive materials therebetween. In alternative embodiments, the common electrode EL2 and the metal line may directly contact each other.

As an example, contact parts CP are respectively disposed in the pixels PX to electrically connect each common electrode EL2 to the adjacent storage line SL. Each of the contact parts CP may have a structure to directly connect each common electrode EL2 to a corresponding storage line SL of the storage lines SL, or a structure to electrically connect each common electrode EL2 to the corresponding storage line SL using a separate member. The structure of the contact parts CP will be described in detail later. In embodiments, the common electrode EL2 and the storage line SL are electrically connected to each other without any switching element, any transistor or any diode therebetween. In an embodiment, the common electrode EL2 and the storage line SL are electrically connected to each other without any semiconductor material therebetween. In another embodiment, the common electrode EL2 and the storage line SL are electrically connected to each other only with a conductive material or conductive materials therebetween. In alternative embodiments, the common electrode EL2 and the storage line SL may directly contact each other.

For the convenience of explanation, the storage lines SL are disposed between the common electrodes EL2 in FIG. 1, but the storage lines SL may be disposed to overlap with the common electrodes EL2.

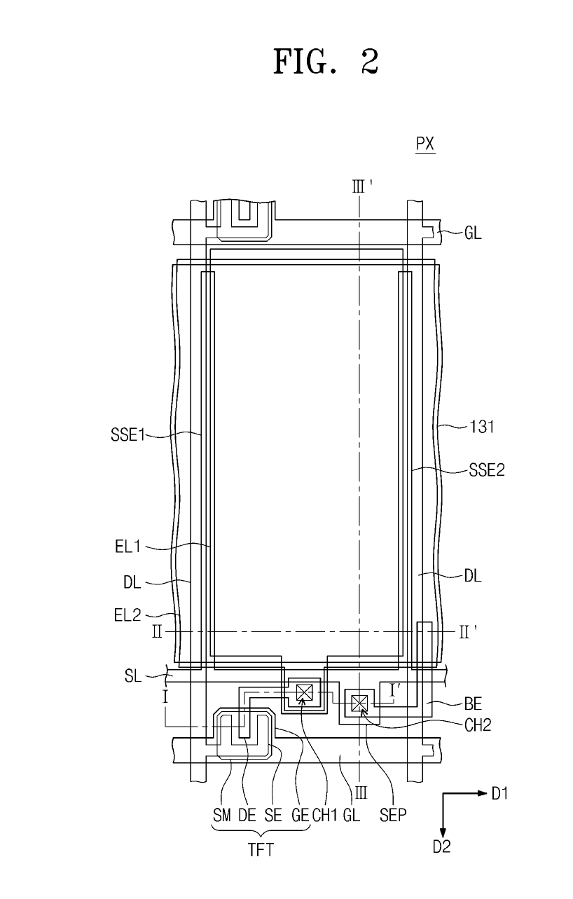

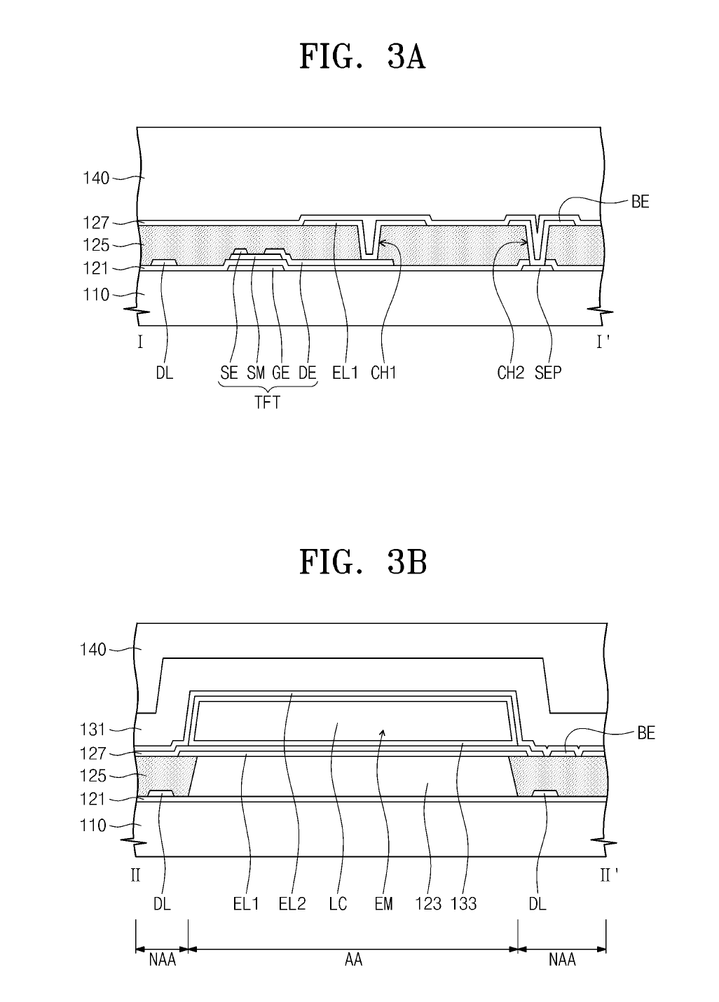

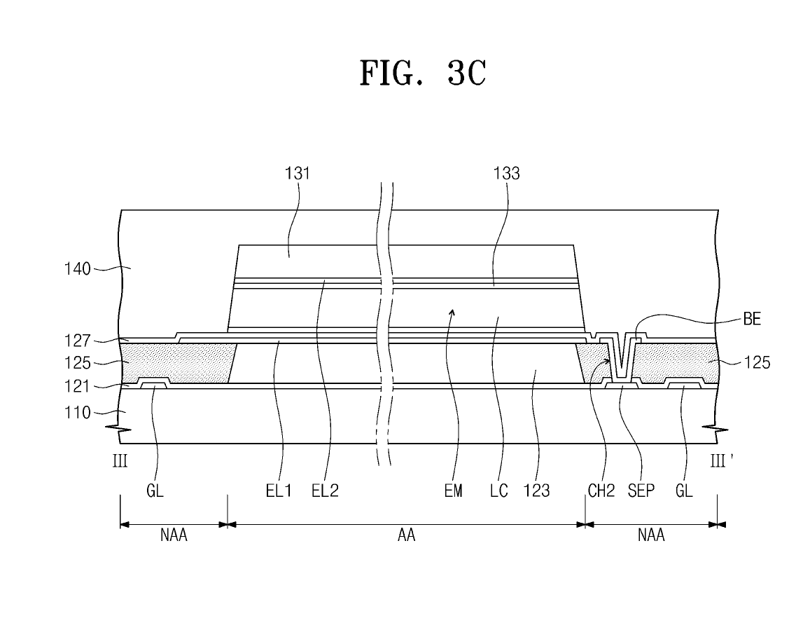

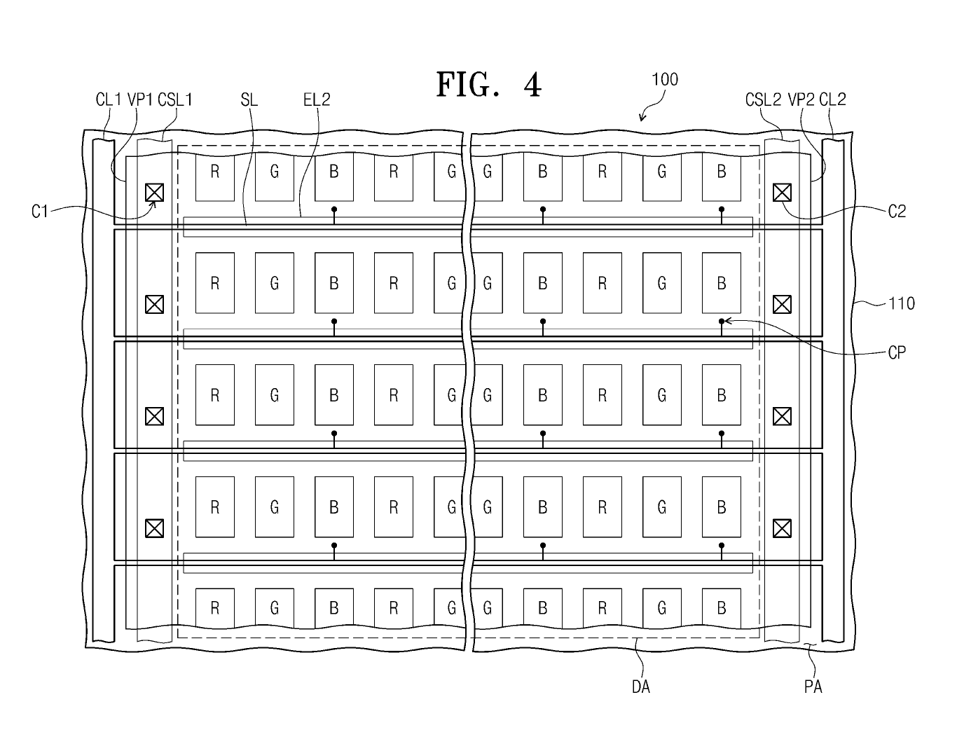

FIG. 2 is a plan view showing the pixel shown in FIG. 1, FIG. 3A is a cross-sectional view taken along a line I-I′ of FIG. 2, FIG. 3B is a cross-sectional view taken along a line II-II′ of FIG. 2, and FIG. 3C is a cross-sectional view taken along a line III-III′ of FIG. 2.

In the present exemplary embodiment, the pixels PX have the same structure and function, and thus, for the convenience of explanation, only one pixel has been shown in FIG. 2. In addition, the pixel has a rectangular shape elongated in one direction, but the shape of the pixel should not be limited to the rectangular shape. That is, the pixel may have various shapes, e.g., a V shape, a Z shape, etc.

Referring to FIGS. 2 and 3A to 3C, the pixel PX is disposed in a pixel area defined by two gate lines GL and two data lines DL. The pixel PX includes a thin film transistor TFT, a pixel electrode EL1, an active cavity EM, and a liquid crystal layer LC contained in the active cavity EM. The liquid crystal material in the active cavities of the pixels forms a liquid crystal layer LC.

The thin film transistor TFT is connected to the gate line GL and the data line DL and includes a gate electrode GE, a semiconductor layer SM, a source electrode SE, and a drain electrode DE.

The gate electrode GE is protruded from the gate line GL or provided on a portion of the gate line GL. The gate line GL and the gate electrode GE includes a metal material, e.g., nickel, chromium, molybdenum, aluminum, titanium, copper, tungsten, and an alloy thereof. The gate line GL and the gate electrode GE have a single-layer structure or a multi-layer structure of the metal material. For instance, the gate line GL and the gate electrode GE have a triple-layer structure of molybdenum-aluminum-molybdenum, which are sequentially stacked one on another, a double-layer structure of titanium and copper, or a single-layer structure of an alloy of copper and titanium.

A first insulating layer 121 is disposed over the entire surface of the base substrate 110 to cover the gate line GL and the gate electrode GE.

The semiconductor layer SM is disposed on the gate electrode GE such that the first insulating layer 121 is disposed between the semiconductor layer SM and the gate electrode GE. The source electrode SE is branched from the data line DL and overlapped with the semiconductor layer SM. The drain electrode DE is spaced apart from the source electrode SE above the semiconductor layer SM. Here, the semiconductor layer SM forms a conductive channel between the source electrode SE and the drain electrode DE.

Each of the source electrode SE and the drain electrode DE includes a conductive material, e.g., a metal material. Each of the source electrode SE and the drain electrode DE includes a single metal material, but it should not be limited thereto or thereby. For instance, each of the source electrode SE and the drain electrode DE includes two or more metal materials or two or more metal alloys. The metal material includes nickel, chromium, molybdenum, aluminum, titanium, copper, tungsten, or an alloy thereof. In addition, each of the source electrode SE and the drain electrode DE has a single-layer structure or a multi-layer structure. As an example, each of the source electrode SE and the drain electrode DE may have a double-layer structure of an alloy of copper and titanium.

A color filter 123 is disposed on the first insulating layer 121. Particularly, the color filter 123 is disposed in an effective area AA used to display the image in the pixel area. The color filter 123 is a red color filter, a green color filter, or a blue color filter and is disposed to correspond to each pixel area. In addition, the color filter 123 may further have the other color, e.g., a white color filter.

A black matrix 125 is further disposed on a portion of the first insulating layer 121 and the thin film transistor TFT. The black matrix 125 is disposed in a non-effective area NAA of the pixel area to block the light that is unnecessary to display the image. The black matrix 125 prevents light leakage or color mixture.

The black matrix 125 is provided with a first contact hole CH1 formed therethrough to expose a portion of the drain electrode DE of the thin film transistor TFT. In the present exemplary embodiment, the first contact hole CH1 is formed by removing a portion of the black matrix 125, but it should not be limited thereto or thereby. According to another embodiment, the first contact hole CH1 may be formed by removing a portion of the color filter 123.

The pixel electrode EL1 is disposed on the color filter 123 and the black matrix 125. The pixel electrode EL1 is electrically connected to the drain electrode DE of the thin film transistor TFT through the first contact hole CH1 formed through the black matrix 125. A second insulating layer 127 is disposed on the pixel electrode EL1 to protect the pixel electrode EL1, but the second insulating layer 127 may be omitted. The second insulating layer 127 includes an organic or inorganic insulating material.

A cover layer 131 that defines the active cavity EM, the liquid crystal layer LC disposed in the active cavity EM, an alignment layer 133 that aligns liquid crystal molecules of the liquid crystal layer LC, and the common electrode EL2 that controls the liquid crystal layer LC in cooperation with the pixel electrode EL1 are disposed on the second insulating layer 127.

The cover layer 131 extends in the first direction D1 on the second insulating layer 127. The cover layer 131 is spaced apart from an upper surface of the second insulating layer 127 to define the active cavity EM in cooperation with the second insulating layer 127. In other words, the cover layer 131 is spaced apart upward from the second insulating layer 127 to form a predetermined space, i.e., the active cavity EM, between the cover layer 131 and the second insulating layer 127. The active cavity EM is formed to correspond to the effective area AA and has a tunnel shape.

Meanwhile, the active cavity EM is not formed in the non-effective area NAA. That is, the cover layer 131 makes contact with the second insulating layer 127 in the non-effective area NAA, and thus a space does not exist between the cover layer 131 and the second insulating layer 127.

The active cavity EM extends in the second direction D2 and both ends of the active cavity EM are opened without being covered by the cover layer 131. Since the liquid crystal molecules are injected into the active cavity EM through the opened both ends, the opened both ends are referred to as inlets. The cover layer 131 may extend in a different direction from the second direction D2.

The cover layer 131 includes an organic or inorganic insulating layer. In addition, the cover layer 131 should not be limited to the single-layer structure. That is, the cover layer 131 may have a multi-layer structure, e.g., a triple-layer structure of inorganic insulating layer-organic insulating layer-inorganic insulating layer, which are sequentially stacked.

The common electrode EL2 is disposed along a lower surface of the cover layer 131 and the common electrode EL2 forms the electric field in cooperation with the pixel electrode EL1. The common electrode EL2 extends in the first direction D1 and is shared by the pixels arranged in the second direction D2.

In addition, the common electrode EL2 is formed along an inner wall of the cover layer 131 that defines the active cavity EM in the effective area AA, and thus the common electrode EL2 is spaced apart from the second insulating layer 127.

The storage line SL and the common electrode EL2 are together disposed on the base substrate 110 and electrically connected to each other. The storage line SL extends along the gate line GL and is disposed between the two gate lines GL. The pixel PX further includes first and second storage electrodes SSE1 and SSE2, which are branched from the storage line SL and overlapped with the pixel electrode EL1. Accordingly, the pixel electrode EL1 faces the first and second storage electrodes SSE1 and SSE2 such that the first insulating layer 121 and the color filter 123 are disposed between the pixel electrode EL1 and the first and second storage electrodes SSE1 and SSE2, thereby forming a storage capacitor.

Further, the pixel PX further includes an extension portion SEP branched from the storage line SL and a bridge electrode BE of which an end portion thereof makes contact with the extension portion SEP and the other end portion thereof makes contact with the common electrode EL2. The extension portion SEP is disposed in the non-effective area NAA. The first insulating layer 121 and the black matrix 125 are provided with a second contact hole CH2 formed therethrough to expose a portion of the extension part SEP. In embodiments, the bridge electrode BE is disposed on the black matrix 125 and an end of the bridge electrode BE makes direct contact with the extension portion SEP through the second contact hole CH2. The other end of the bridge electrode BE is partially exposed by the second insulating layer 127, and the common electrode EL2 disposed on the second insulating layer 127 makes direct contact with the exposed bridge electrode BE.

Thus, the common electrode EL2 is electrically connected to the storage line SL through the bridge electrode BE and receives the storage voltage as the common voltage. As a result, the electric potential of the common electrode EL2 may be prevented from being lowered in the center portion of the display area DA (refer to FIG. 1), and thus the crosstalk defect may be improved. In embodiments, the common electrode EL2 and the bridge electrode BE are electrically connected to each other without any switching element, any transistor or any diode therebetween. In an embodiment, the common electrode EL2 and the bridge electrode BE are electrically connected to each other without any semiconductor material therebetween. In another embodiment, the common electrode EL2 and the bridge electrode BE directly contact each other.

Each of the pixel electrode EL1 and the common electrode EL2 includes a transparent conductive material or a non-transparent conductive material, e.g., a metal material. That is, each of the pixel electrode EL1 and the common electrode EL2 includes the transparent or non-transparent conductive material according to an operation mode of the display apparatus 100 according to the present exemplary embodiment. For instance, when the display apparatus 100 is a transmissive type display apparatus employing a backlight unit disposed under the base substrate 110, the pixel electrode EL1 and the common electrode EL2 include the transparent conductive material. When the display apparatus 100 is a reflective type display apparatus operated without using the backlight unit, however, the pixel electrode EL1 includes the non-transparent conductive material, e.g., a material that reflects the light, and the common electrode EL2 includes the transparent conductive material. The transparent conductive material includes a transparent conductive oxide, such as indium tin oxide, indium zinc oxide, indium tin zinc oxide, etc. The non-transparent conductive material includes the metal material, such as nickel, chromium, molybdenum, aluminum, titanium, copper, tungsten, and an alloy thereof. The other components in the display apparatus 100, e.g., the cover layer 131, include the transparent or non-transparent conductive material according to the operation mode of the display apparatus 100.

The liquid crystal LC is injected into the active cavity EM through the inlets. The active cavity EM is defined a space which is form between the pixel electrode EL1 and the common electrode EL2. Therefore, the pixel electrode EL1, the liquid crystal LC, and the common electrode EL2 may be together formed on one base substrate 110. According to the present exemplary embodiment, the liquid crystal LC is disposed between the pixel electrode EL1 and the common electrode EL2, which face each other, and controlled by a vertical electric field formed between the pixel electrode EL1 and the common electrode EL2, thereby displaying a desired image.

The liquid crystal LC includes the liquid crystal molecules having optical anisotropy. The liquid crystal LC may include vertical alignment nematic liquid crystal molecules. The liquid crystal molecules are driven by the vertical electric field to transmit or block the light passing therethrough.

The alignment layer 133 is disposed between the pixel electrode EL1 and the liquid crystal LC and between the common electrode EL2 and the liquid crystal LC. The alignment layer 133 may be vertical alignment layer. The alignment layer 133 is used to pretilt the liquid crystal molecules of the liquid crystal LC and includes an organic polymer, such as polyimide and/or polyamic acid.

Meanwhile, an inorganic insulating layer (not shown) may be further disposed between the liquid crystal LC and the common electrode EL2 and/or between the common electrode EL2 and the cover layer 131. The inorganic insulating layer includes silicon nitride or silicon oxide. The inorganic insulating layer supports the cover layer 131 to stably maintain the active cavity EM.

A sealing layer 140 is disposed on the cover layer 131. The sealing layer 140 is disposed in the effective area AA and the non-effective area NAA. The sealing layer 140 blocks the opened both ends, i.e., the inlets, of the active cavity EM in the non-effective area NAA to seal the active cavity EM.

The sealing layer 140 includes an organic polymer. As the organic polymer, poly(p-xylene)polymer, i.e., parylene, may be used.

Although not shown in figures, first and second polarizing plates are respectively disposed on a lower surface of the base substrate 110 and an upper surface of the sealing layer 140. In addition, a first quarter-wavelength plate is disposed between the base substrate 110 and the first polarizing plate and a second quarter-wavelength plate is disposed between the sealing layer 140 and the second polarizing plate. As an example, the first polarizing plate has a polarizing axis substantially vertical to a polarizing axis of the second polarizing plate. A long axis of the first quarter-wavelength plate is substantially perpendicular to a long axis of the second quarter-wavelength plate.

The liquid crystal layer LC having the above-mentioned structure is driven by an electrically controlled birefringence (ECB) mode in which the liquid crystal molecules are positive type liquid crystal molecules. However, a part of the optical member may be omitted or further include additional parts in accordance with the type of the liquid crystal layer LC, e.g., a positive type or a negative type, and the driving mode of the display device, e.g., an in-plane switching mode, a vertical alignment mode, the ECB mode, etc. In addition, the arrangement of the polarizing axes of the first and second polarizing plates and the long axes of the first and second quarter-wavelength plates may be changed according to the type of the liquid crystal layer LC and the driving mode of the display device.

FIG. 4 is a plan view showing a display apparatus according to another exemplary embodiment of the present disclosure. In FIG. 4, the same reference numerals denote the same elements in FIG. 1, and thus detailed descriptions of the same elements will be omitted.

Referring to FIG. 4, the contact parts CP, which electrically connect the common electrodes EL2 to the storage lines SL, are disposed in the pixels PX (hereinafter, referred to as blue pixels) corresponding to blue color pixels B. Since the blue pixels have a relatively high brightness at the same gray scale when compared to that of red and green color pixels, the blue color pixels PX do not exert influence on brightness characteristics of the display apparatus 100 even though the brightness is lower due to a reduction of an aperture ratio caused by the contact parts CP.

Although not shown in figures, the contact parts CP may be provided in the unit of two pixels, or four or more pixels.

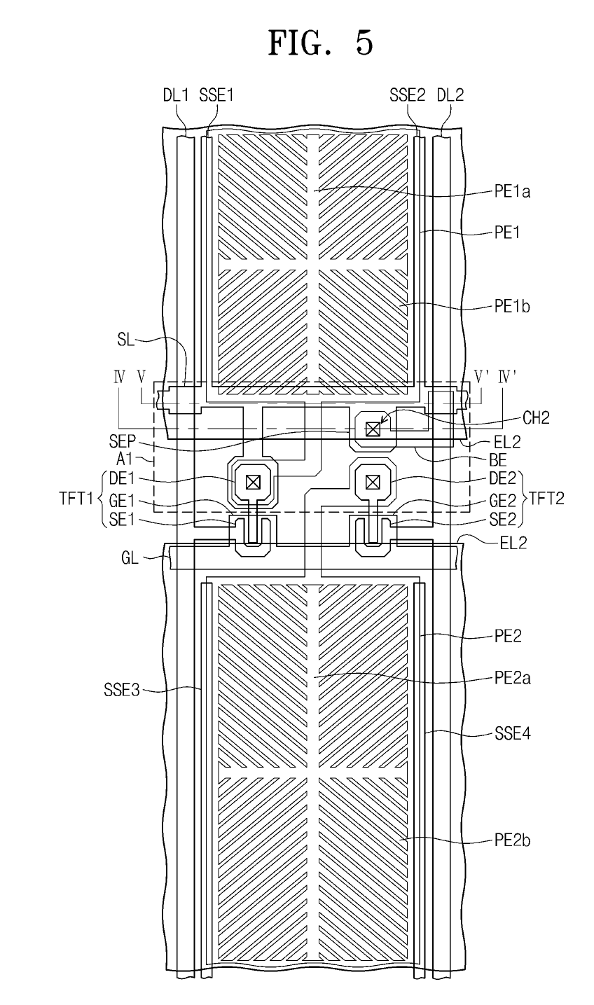

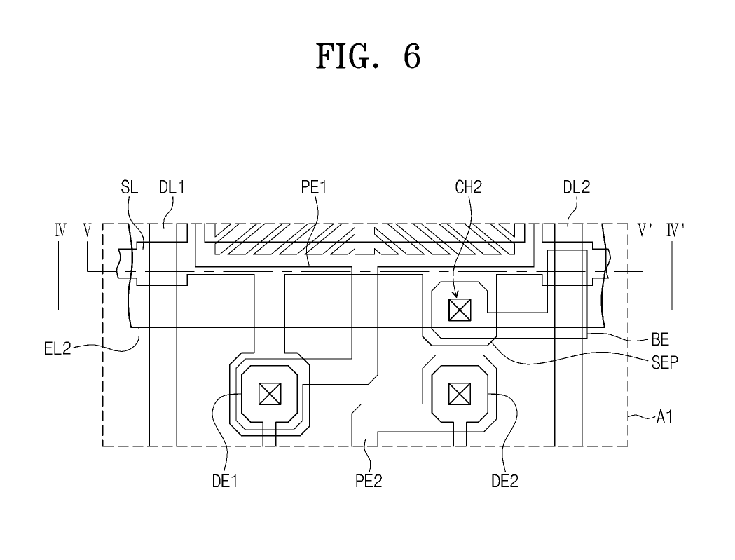

FIG. 5 is a plan view showing a pixel according to another exemplary embodiment of the present disclosure and FIG. 6 is an enlarged view showing a portion A1 shown in FIG. 5.

Referring to FIGS. 5 and 6, a pixel PX includes a first sub-pixel including a first sub-pixel electrode PE1 and a first thin film transistor TFT1 and a second sub-pixel including a second sub-pixel electrode PE2 and a second thin film transistor TFT2. The first and second sub-pixel electrodes PE1 and PE2 are arranged in the second direction D2, and a gate line GL and a storage line SL are disposed between the first sub-pixel electrode PE1 and the second sub-pixel electrode PE2.

In addition, a first data line DL1 is disposed at one side of the first and second sub-pixel electrodes PE1 and PE2 and a second data line DL2 is disposed at the other side of the first and second sub-pixel electrodes PE1 and PE2. The gate line GL and the storage line SL extend in the first direction D1 and are spaced apart from each other. The first and second data lines DL1 and DL2 extend in the second direction D2 and are spaced apart from each other such that the first and second sub-pixel electrode PE1 and PE2 are disposed between the first and second data lines DL1 and DL2.

The first thin film transistor TFT1 is connected to the first data line DL1 and the gate line GL. In detail, the first thin film transistor TFT1 includes a first gate electrode GE1 branched from the gate line GL, a first source electrode SE1 branched from the first data line DL1, and a first drain electrode DE1 spaced apart from the first source electrode SE1 and electrically connected to the first sub-pixel electrode PE1. The second thin film transistor TFT is connected to the second data line DL2 and the gate line GL. In detail, the second thin film transistor TFT2 includes a second gate electrode GE1 branched from the gate line GL, a second source electrode SE2 branched from the second data line DL2, and a second drain electrode DE2 spaced apart from the second source electrode SE2 and electrically connected to the second sub-pixel electrode PE2.

The first sub-pixel electrode PE1 is overlapped with first and second storage electrodes SSE1 and SSE2 extending from the storage line SL in the first direction D1 to form a first storage capacitor. In addition, the second sub-pixel electrode PE2 is overlapped with third and fourth storage electrodes SSE3 and SSE4 extending from the storage line SL in the first direction D1 to form a second storage capacitor. The first and third storage electrodes SSE1 and SSE3 are disposed adjacent to the first data line DL1 and the second and fourth storage electrodes SSE2 and SSE4 are disposed adjacent to the second data line DL2.

The first sub-pixel electrode PE1 includes a first trunk portion PE1a and a plurality of first branch portions PE1b extending from the first trunk portion PE1a in radial form. The first trunk portion PE1a has a cross shape and the first sub-pixel electrode PE1 includes a plurality of areas divided by the first trunk portion PE1a. The first sub-pixel electrode PE1 includes a plurality of domains defined by the first trunk portion PE1a. The first branch portions PE1b extend in different directions according to the domains. In the present exemplary embodiment, the first sub-pixel electrode PE1 includes four domains, but the number of the domains should not be limited to four. The first branch portions PE1b are spaced apart from each other and extend substantially in parallel to each other in each area defined by the first trunk portion PE1a. The distance between two adjacent first branch portions PE1b to each other is measured in terms of a micrometer. This is to align the liquid crystal molecules of the liquid crystal layer LC in a specific azimuth on a plane substantially parallel to the base substrate 110.

In addition, the second sub-pixel electrode PE2 includes a second trunk portion PE2a and a plurality of second branch portions PE2b extending from the second trunk portion PE2a in radial form. The second trunk portion PE2a has a cross shape and the second sub-pixel electrode PE2 includes a plurality of areas divided by the second trunk portion PE2a. The second sub-pixel electrode PE2 includes a plurality of domains defined by the second trunk portion PE2a. The second branch portions PE2b extend in different directions according to the domains. In the present exemplary embodiment, the second sub-pixel electrode PE2 includes four domains, but the number of the domains should not be limited to four. The second branch portions PE2b are spaced apart from each other and extend substantially in parallel to each other in each area defined by the second trunk portion PE2a. The distance between two adjacent second branch portions PE2b to each other is measured in terms of a micrometer. This is to align the liquid crystal molecules of the liquid crystal layer LC in a specific azimuth on the plane substantially parallel to the base substrate 110.

In the present exemplary embodiment, the liquid crystal molecules are aligned in different directions according to the domains and the first and second sub-pixel electrodes PE1 and PE2 are applied with different voltages. Therefore, alignment directions of the liquid crystal molecules are controlled to be different, so that a viewing angle of the display apparatus 100 is improved.

In addition, the pixel PX further includes an extension part SEP branched from the storage line SL and a bridge electrode BE of which one end thereof makes contact with the extension part SEP and the other end thereof makes contact with the common electrode EL2. In embodiments, the one end of the bridge electrode BE makes direct contact with the extension part SEP through the second contact hole CH2 and the other end of the bridge electrode BE makes direct contact with the common electrode EL2.

Thus, the common electrode EL2 is electrically connected to the storage line SL through the bridge electrode BE and receives the storage voltage as the common voltage. As a result, the electric potential of the common electrode EL2 may be prevented from being lowered in the center portion of the display area DA (refer to FIG. 1), and thus the crosstalk defect may be improved. In embodiments, the storage line SL and the bridge electrode BE are electrically connected to each other without any switching element, any transistor or any diode therebetween. In an embodiment, the storage line SL and the bridge electrode BE are electrically connected to each other without any semiconductor material therebetween. In another embodiment, the storage line SL and the bridge electrode BE may directly contact each other.

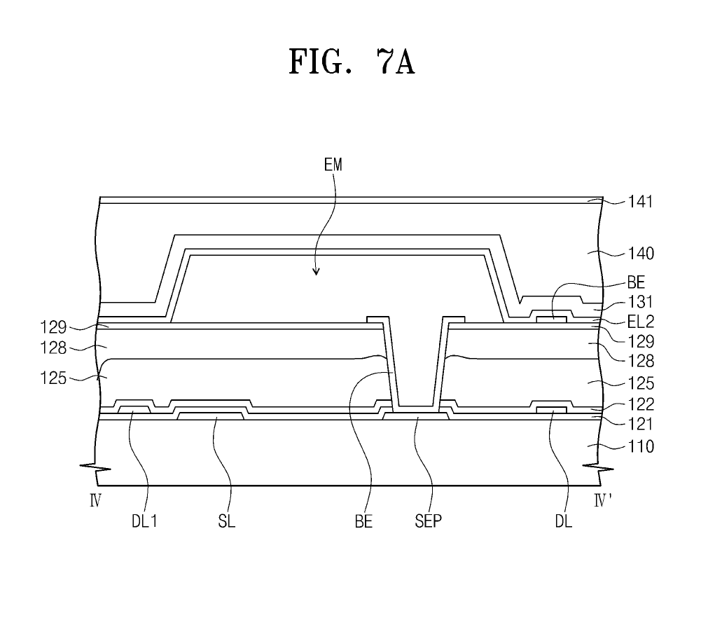

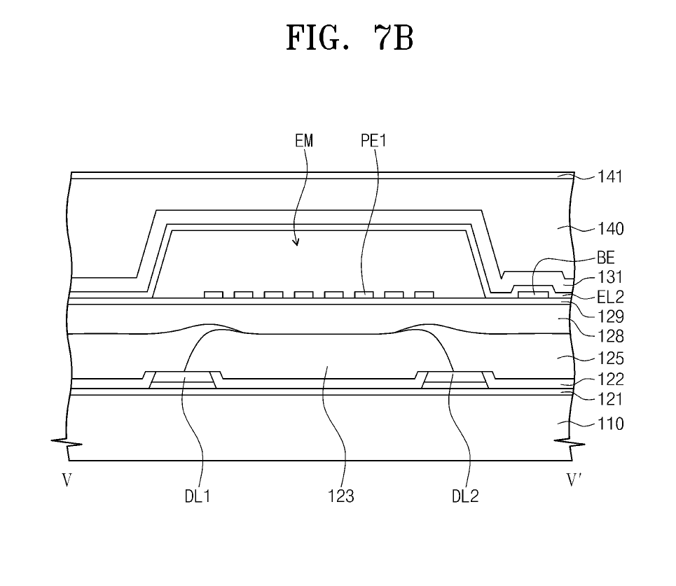

FIG. 7A is a cross-sectional view taken along a line IV-IV′ shown in FIG. 5 and FIG. 7B is a cross-sectional view taken along a line V-V′ shown in FIG. 5.

Referring to FIGS. 7A and 7B, a first insulating layer 121 is disposed over the entire surface of the base substrate 110 to cover the gate line GL and the first and second gate electrodes GE1 and GE2.

The first and second data lines DL1 and DL2, the first and second source electrodes SE1 and SE2, and the first and second drain electrodes DE1 and DE2 are disposed on the first insulating layer 121. Those are formed of a single metal material, but they should not be limited thereto or thereby. In addition, as shown in FIGS. 7A and 7B, the first and second data lines DL1 and DL2 are covered by a first protective layer 122. Although not shown in figures, the first protective layer 122 covers the first and second source electrodes SE1 and SE2 and the first and second drain electrodes DE1 and DE2.

A black matrix 125 and a color filter 123 are disposed on the first protective layer 122. The color filter 123 is disposed in the effective area of the pixel area, in which the image is displayed, and the black matrix 125 is disposed in the non-effective area of the pixel area to block the light that is unnecessary to display the image. As an example, an organic layer 128 and a second protective layer 129 may further be disposed on the black matrix 125 and the color filter 123.

As shown in FIG. 7A, the second contact hole CH2 is formed through the first insulating layer 121, the first protective layer 122, the black matrix 125, the organic layer 128, and the second protective layer 129 to expose the extension part SEP extending from the storage line SL.

The first and second sub-pixels PE1 and PE2 are disposed on the second protective layer 129. In addition, as an example, the bridge electrode BE is disposed on the second protective layer 129. In embodiments, the bridge electrode BE makes direct contact with the extension part SEP through the second contact hole CH2.

The cover layer 131 that defines the active cavity EM, the liquid crystal layer LC disposed in the active cavity EM, and the common electrode EL2 that controls the liquid crystal layer LC in cooperation with the first and second sub-pixel electrodes PE1 and PE2 are disposed on the second protective layer 129.

The cover layer 131 extends in the first direction D1 on the second protective layer 129. The cover layer 131 is spaced apart from an upper surface of the second protective layer 129 to define the active cavity EM in cooperation with the second protective layer 129. In other words, the cover layer 131 is spaced apart upward from the second protective layer 129 to form a predetermined space between the cover layer 131 and the second protective layer 129 as the active cavity EM. Accordingly, the active cavity EM has the tunnel shape.

The active cavity EM extends in the second direction D2 and both ends of the active cavity EM are opened without being covered by the cover layer 131. Since the liquid crystal molecules are injected into the active cavity EM through the opened both ends of the active cavity EM, the opened both ends are referred to as inlets. The cover layer 131 may extend in a different direction from the second direction D2.

The cover layer 131 includes an organic or inorganic insulating layer. In addition, the cover layer 131 should not be limited to the single-layer structure. That is, the cover layer 131 may have a multi-layer structure, e.g., a triple-layer structure of inorganic insulating layer-organic insulating layer-inorganic insulating layer, which are sequentially stacked.

The common electrode EL2 is disposed along a lower surface of the cover layer 131 and the common electrode EL2 forms the electric field in cooperation with the first and second sub-pixel electrodes PE1 and PE2. The common electrode EL2 extends in the first direction D1 and is shared by the pixels arranged in the second direction D2.

In addition, the common electrode EL2 may be formed along an inner wall of the cover layer 131 that defines the active cavity EM.

Meanwhile, the common electrode EL2 is partially overlapped with the bridge electrode BE outside the active cavity EM. As described above, in embodiments, the one end of the bridge electrode BE makes direct contact with the extension part SEP through the second contact hole CH2. The other end of the bridge electrode BE is disposed on the second protective layer 129 outside the active cavity EM and makes direct contact with the common electrode EL2.

Thus, the common electrode EL2 is electrically connected to the storage line SL through the bridge electrode BE and receives the storage voltage as the common voltage. As a result, the electric potential of the common electrode EL2 may be prevented from being lowered in the center portion of the display area DA (refer to FIG. 1), and thus the crosstalk defect may be improved.

A sealing layer 140 and a third protective layer 141 are sequentially disposed on the cover layer 131. The sealing layer 140 blocks the opened both ends, i.e., the inlets, of the active cavity EM to seal the active cavity EM. The sealing layer 140 includes an organic polymer. The third protective layer 141 includes the inorganic insulating layer to prevent moisture or air from entering into the sealing layer 140.

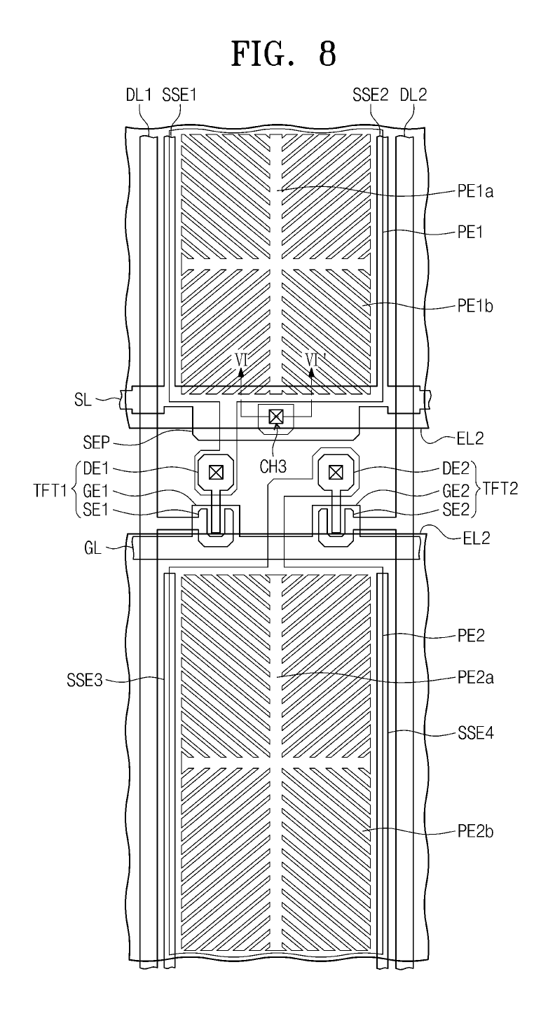

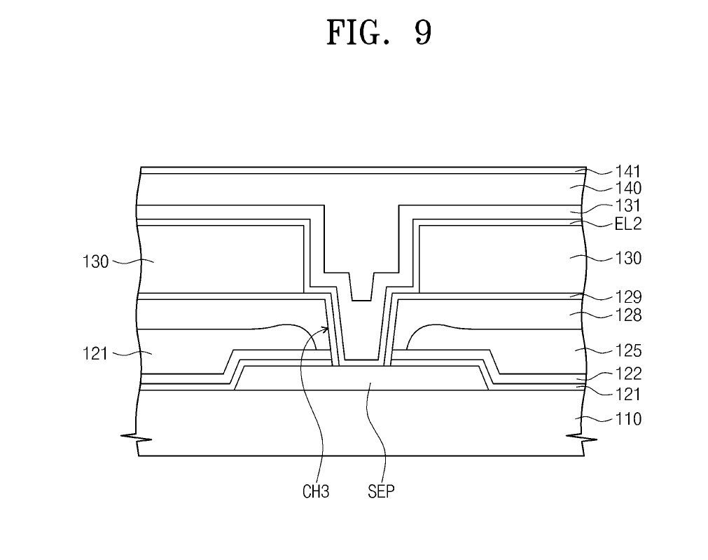

FIG. 8 is a plan view showing a pixel according to another exemplary embodiment of the present disclosure and FIG. 9 is a cross-sectional view taken along a line VI-VI′ shown in FIG. 8. In FIGS. 8 and 9, the same reference numerals denote the same elements in FIGS. 5 to 7B, and thus detailed descriptions of the same elements will be omitted.

Referring to FIGS. 8 and 9, the pixel PX further includes an extension part SEP extending from the storage line SL. The extension part SEP makes direct contact with the common electrode EL2 through a third contact hole CH3.

As shown in FIG. 9, the third contact hole CH3 includes a first open area formed by opening the first insulating layer 121, the first protective layer 122, the black matrix 125, and the organic layer 128 and a second open area formed by opening the second protective layer 129 and a barrier layer 130.

The barrier layer 130 is disposed at positions corresponding to the inlet of the active cavity EM. The barrier layer 130 may be disposed in the non-effective area right adjacent to the inlet.

The barrier layer 130 is disposed between the cover layer 131 and the second protective layer 129 to make direct contact with the second protective layer 129 and has a column shape. The barrier layer 130 is divided into two portions spaced apart from each other by the second open area. The two portions of the barrier layer 130 faces each other such that a center line of a widthwise direction vertical to a lengthwise direction of the active cavity EM is disposed therebetween. Therefore, the barrier layer 130 blocks a portion of the inlet. The inlet is disposed between the two portions of the barrier layer 130 and the liquid crystal layer LC is filled in the active cavity EM through the inlet.

Although not shown in figures, the barrier layer 130 may be integrally formed with the cover layer 131.

The common electrode EL2 is formed on an inner wall of the active cavity EM in the effective area, but disposed on the barrier layer 130 in the non-effective area as shown in FIG. 9.

In embodiments, the common electrode EL2 makes direct contact with the extension part SEP extending from the storage line SL through the third contact hole CH3.

Thus, the common electrode EL2 is electrically connected to the storage line SL through the bridge electrode BE and receives the storage voltage as the common voltage. As a result, the electric potential of the common electrode EL2 may be prevented from being lowered in the center portion of the display area DA (refer to FIG. 1), and thus the crosstalk defect may be improved.

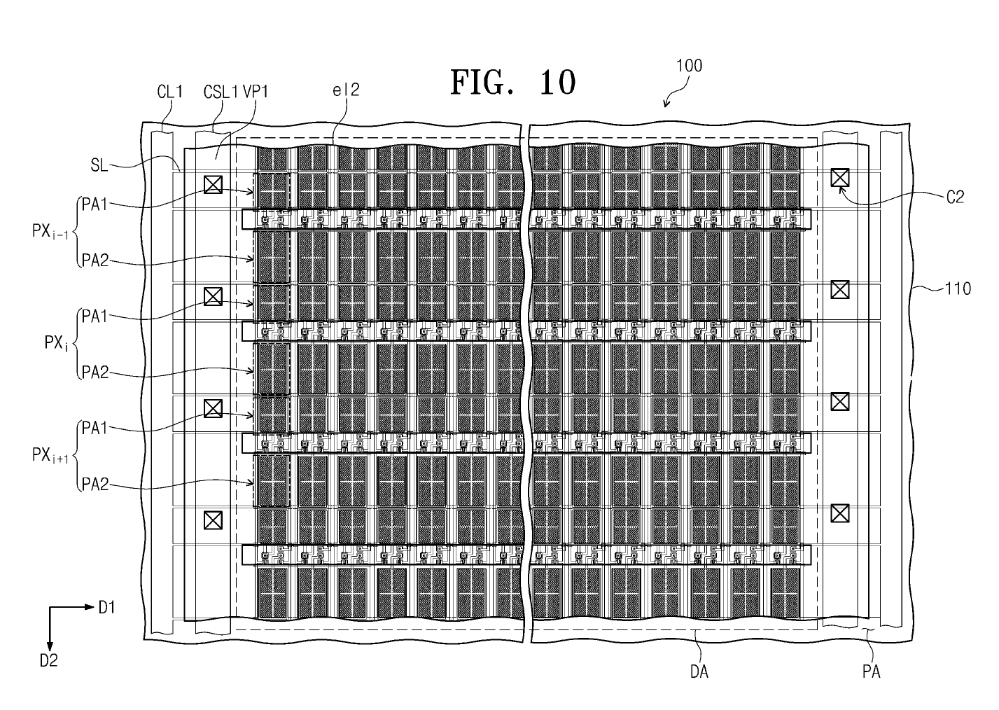

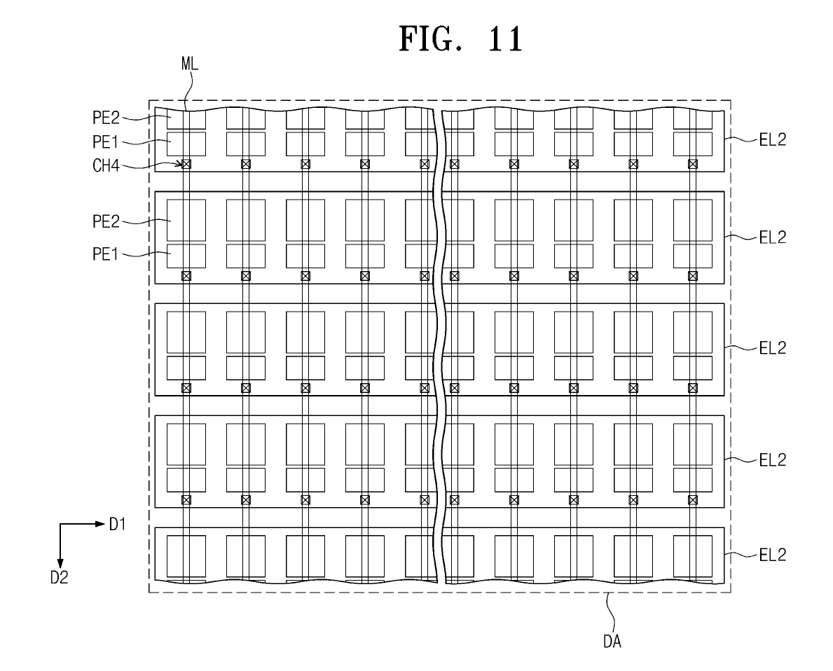

FIG. 10 is a plan view showing a display apparatus according to another exemplary embodiment of the present disclosure. In FIG. 10, the same reference numerals denote the same elements in FIG. 1, and thus detailed descriptions of the same elements will be omitted.

Referring to FIG. 10, the pixels are arranged on the base substrate 110 in a matrix form. Each pixel includes first and second pixel areas PA1 and PA2 in which first and second sub-pixels are respectively disposed. The non-effective area is disposed between the first sub-pixel area PA1 and the second sub-pixel area PA2. The first and second thin film transistors TFT1 and TFT2 and the second contact hole CH2 are disposed in the non-effective area. The first and second sub-pixel areas PA1 and PA2 are alternately arranged in a column direction.

In addition, the common electrodes EL2 extend in the first direction D1 and are arranged in the second direction D2 to be spaced apart from each other by a predetermined distance. An area between the common electrodes EL2 corresponds to the non-effective area between the first sub-pixel area PA1 and the second sub-pixel area PA2.

As an example, each common electrode EL2 has a width corresponding to the first and second sub-pixel areas PA1 and PA2 and extends in the row direction. In detail, an i-th common electrode (“i” is an integer number equal to or greater than 2) among the common electrodes EL2 is disposed to overlap with the first sub-pixel area PA1 of an i-th pixel PXi and the second sub-pixel area PA2 of an (i−1)th pixel PXi−1, and an (i+1)th common electrode is disposed to overlap with the second sub-pixel area PA2 of the i-th pixel PXi and the first sub-pixel area PA1 of an (i+1)th pixel PXi+1.

Each common electrode EL2 is electrically connected to an adjacent storage line SL thereto. As shown in FIG. 10, each common electrode EL2 is overlapped with two storage lines of the storage lines SL and electrically connected to one of the two storage lines. The contact parts are disposed in the non-effective area corresponding to the area between the common electrodes EL2 to electrically connect the common electrodes EL2 and the storage lines SL. Therefore, the aperture ratio of the pixels may be prevented from being lowered due to the contact parts. In embodiments, the common electrode EL2 and the storage line SL are electrically connected to each other without any switching element, any transistor or any diode therebetween. In an embodiment, the common electrode EL2 and the storage line SL are electrically connected to each other without any semiconductor material therebetween. In another embodiment, the common electrode EL2 and the storage line SL are electrically connected to each other only with a conductive material or conductive materials therebetween. In alternative embodiments, the common electrode EL2 and the storage line SL may directly contact each other.

Thus, the common electrode EL2 is electrically connected to the storage line SL and receives the storage voltage as the common voltage. As a result, the electric potential of the common electrode EL2 may be prevented from being lowered in the center portion of the display area DA, and thus the crosstalk defect may be improved.

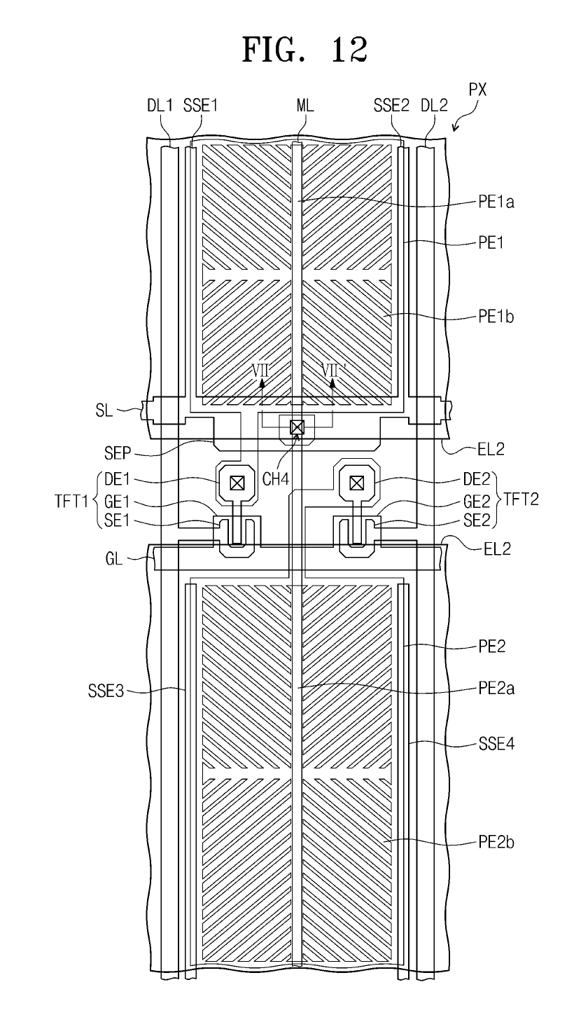

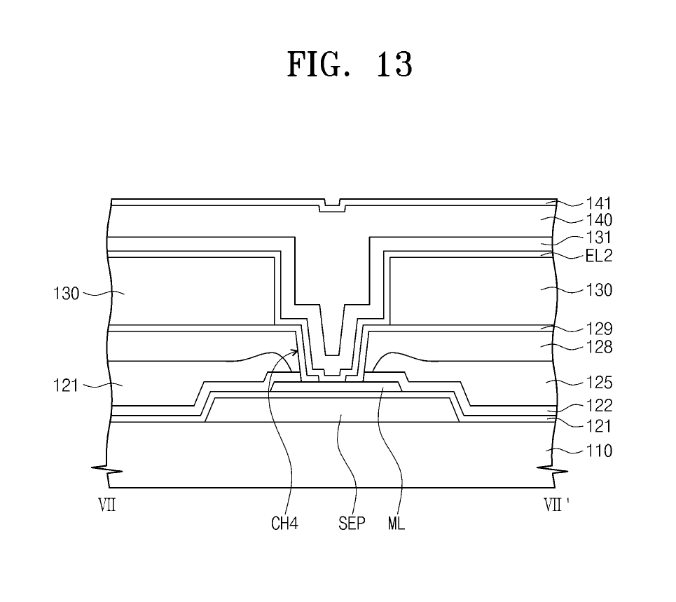

FIG. 11 is a plan view showing a display apparatus according to another exemplary embodiment of the present disclosure, FIG. 12 is a plan view showing a pixel shown in FIG. 11, and FIG. 13 is a cross-sectional view taken along a line VII-VIP shown in FIG. 12. In FIGS. 11 to 13, the same reference numerals denote the same elements in FIGS. 8 and 9, and thus detailed descriptions of the same elements will be omitted.

FIG. 11 show only the display area DA of the display apparatus 110, but the peripheral area PA is disposed adjacent to one or both sides of the display area DA or disposed to surround the display area DA.

The display area DA of the display apparatus 100 includes the pixels PX arranged therein to display the image. As shown in FIG. 12, each pixel PX includes a first sub-pixel electrode PE1 and a second sub-pixel electrode PE2.

The common electrodes EL2 are further disposed in the display area DA. The common electrodes EL2 extend in the first direction D1 and are arranged in the second direction D2 in the display area DA. The common electrodes EL2 are spaced apart from each other by a predetermined distance in the second direction D2. As an example, the area between the common electrodes EL2 corresponds to the area between the first and second sub-pixel electrodes PE1 and PE2 in the same pixel.

In addition, a metal line ML is disposed in the display area DA to electrically connect the common electrodes EL2. The metal line ML extends in the second direction D2 and crosses the common electrodes EL2 to overlap with the common electrodes EL2. In embodiments, the common electrode EL2 and the metal line ML are electrically connected to each other without any switching element, any transistor or any diode therebetween. In an embodiment, common electrode EL2 and the metal line ML are electrically connected to each other without any semiconductor material therebetween. In another embodiment, the common electrode EL2 and the metal line ML are electrically connected to each other only with a conductive material or conductive materials therebetween. In alternative embodiments, common electrode EL2 and the metal line ML may directly contact each other.

The pixels PX are arranged in the display area DA of the base substrate 110 in the matrix form of rows by columns. In the present exemplary embodiment, the pixels PX have the same structure and function, only one pixel PX will be described in detail later.

As shown in FIG. 12, the pixel PX includes a first sub-pixel including a first sub-pixel electrode PE1 and a first thin film transistor TFT1 and a second sub-pixel including a second sub-pixel electrode PE2 and a second thin film transistor TFT2. The first and second sub-pixel electrodes PE1 and PE2 are arranged in the second direction D2 and a gate line GL and a storage line SL are disposed between the first sub-pixel electrode PE1 and the second sub-pixel electrode PE2. The gate line GL and the storage line SL extend in the first direction D1.

In addition, a first data line DL1 is disposed at one side of the first and second sub-pixel electrodes PE1 and PE2 and a second data line DL2 is disposed at the other side of the first and second sub-pixel electrodes PE1 and PE2. The first and second data lines DL1 and DL2 extend in the second direction D2 and are spaced apart from each other such that the first and second sub-pixel electrodes PE1 and PE2 are disposed between the first and second data lines DL1 and DL2.

The first sub-pixel electrode PE1 includes a first trunk portion PE1a and a plurality of first branch portions PE1b extending from the first trunk portion PE1a in radial form.

The first trunk portion PE1a has a cross shape and the first sub-pixel electrode PE1 is divided into four domains by the first trunk portion PE1a. The first branch portions PE1b extend in different directions according to the domains. The first branch portions PE1b are spaced apart from each other and extend substantially in parallel to each other in each domain.

In addition, the second sub-pixel electrode PE2 includes a second trunk portion PE2a and a plurality of second branch portions PE2b extending from the second trunk portion PE2a in radial form. The second trunk portion PE2a has a cross shape and the second sub-pixel electrode PE2 is divided into plural domains by the second trunk portion PE2a. The second branch portions PE2b extend in different directions according to the domains. The second branch portions PE2b are spaced apart from each other and extend substantially in parallel to each other in each domain defined by the second trunk portion PE2a.

The metal line ML is disposed between the first and second data lines DL1 and DL2 to correspond to the non-effective display area of the first and second sub-pixel electrodes PE1 and PE2 between the first and second data lines DL1 and DL2.

As an example, the metal line ML is disposed to face a portion of the first trunk portion PE1a, which extends in the second direction D2, and a portion of the second trunk portion PE2a, which extends in the second direction D2.

As shown in FIG. 13, the metal line ML is disposed on the first insulating layer 121 as the first and second data lines DL1 and DL2.

In embodiments, the metal line ML makes direct contact with the common electrode EL2 through a fourth contact hole CH4. The fourth contact hole CH4 includes a first open area defined by opening the first protective layer 122, the black matrix 125, and the organic layer 128 and a second open area defined by opening the second protective layer 129 and the barrier layer 130.

The barrier layer 130 is disposed at a position corresponding to the inlet of the active cavity EM. In the present exemplary embodiment, the barrier layer 130 may be disposed in the non-effective area right adjacent to the inlet.

The common electrode EL2 is disposed on the inner wall of the active cavity EM in the effective area, but disposed on the barrier layer 130 in the non-effective area as shown in FIG. 13.

In embodiments, the common electrode EL2 makes direct contact with the metal line ML through the fourth contact hole CH4.

In the same way, the metal line ML makes electrically contact with the common electrodes EL2 arranged in the second direction D2 to electrically connect the common electrodes EL2 to each other.

In addition, the metal line ML includes the same metal material as that of the first and second data lines DL1 and DL2, and thus the metal line ML has resistance lower than that of the transparent conductive oxide, e.g., indium tin oxide, indium zinc oxide, etc., used to form the common electrodes EL2.

As described above, when the common electrodes EL2 are electrically connected to each other in the second direction D2 by the metal line ML having the resistance lower than that of the common electrodes EL2, the electric potential of each common electrode EL2 may be prevented from being lowered in the center portion of the display area DA, and thus the crosstalk defect may be improved.

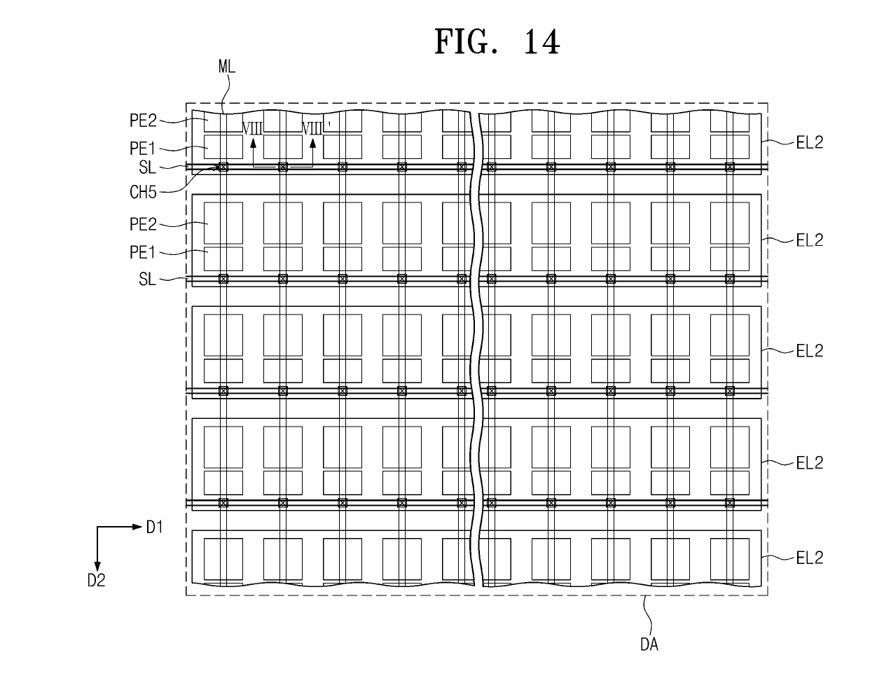

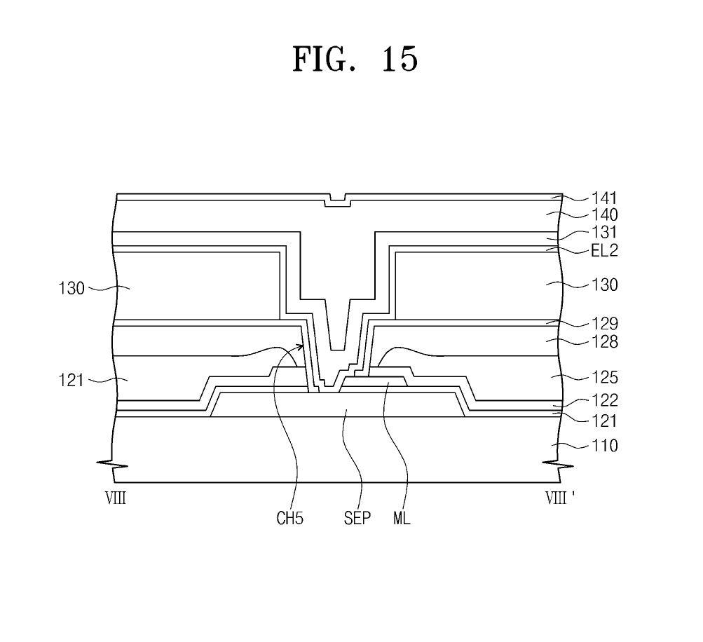

FIG. 14 is a plan view showing a display apparatus according to another exemplary embodiment of the present disclosure and FIG. 15 is a cross-sectional view taken along a line VIII-VIII′ shown in FIG. 14. In FIGS. 14 and 15, the same reference numerals denote the same elements in FIGS. 11 to 13, and thus detailed descriptions of the same elements will be omitted.

Referring to FIGS. 14 and 15, the pixel PX further includes the extension part SEP (refer to FIG. 12) extending from the storage line SL. The extension part SEP is disposed to overlap with the metal line ML.

In embodiments, the common electrode EL2 makes direct contact with the metal line ML and the extension part SEP through a fifth contact hole CH5. The fifth contact hole CH5 includes a third open area to expose the extension part SEP and a fourth open area to expose the metal line ML.

The third open area is defined by opening the first insulating layer 121, the first protective layer 122, the black matrix 125, and the organic layer 128 and the fourth open area is defined by opening the first protective layer 122, the black matrix 125, and the organic layer 128. The second open area defined by the second protective layer 129 and the barrier layer 130 is disposed above the third and fourth open areas.

In the same way, the metal line ML and the storage line SL are electrically connected to the common electrodes EL2 arranged in the second direction D2 to electrically connect the common electrodes EL2 to each other. In embodiments, the common electrode EL2, the metal line ML and the storage line SL are electrically connected to each other without any switching element, any transistor or any diode therebetween. In an embodiment, the common electrode EL2, the metal line ML and the storage line SL are electrically connected to each other without any semiconductor material therebetween. In another embodiment, the common electrode EL2, the metal line ML and the storage line SL are electrically connected to each other only with a conductive material or conductive materials therebetween. In alternative embodiments, the metal line ML and the storage line SL may directly contact each other.

In addition, the metal line ML and the storage line SL include the metal material having the resistance lower than that of the transparent conductive oxide, e.g., indium tin oxide, indium zinc oxide, etc., used to form the common electrodes EL2.

As described above, the common electrodes EL2 are electrically connected to each other in the second direction D2 by the metal line ML having the resistance lower than that of the common electrodes EL2 and the voltage down in the first direction D1 of each common electrode EL2 is compensated. Thus, the electric potential of each common electrode EL2 may be prevented from being lowered in the center portion of the display area DA, and thus the crosstalk defect may be improved.

For the convenience of explanation, each common electrode EL2 is partially overlapped with the storage lines SL in FIG. 14, but the common electrodes EL2 may be formed to cover the whole of the storage line SL and the extension part SEP when viewed in a plan view.

In addition, in embodiments, the extension part SEP may be omitted, and in this case, the metal line ML may make direct contact with the storage line SL.

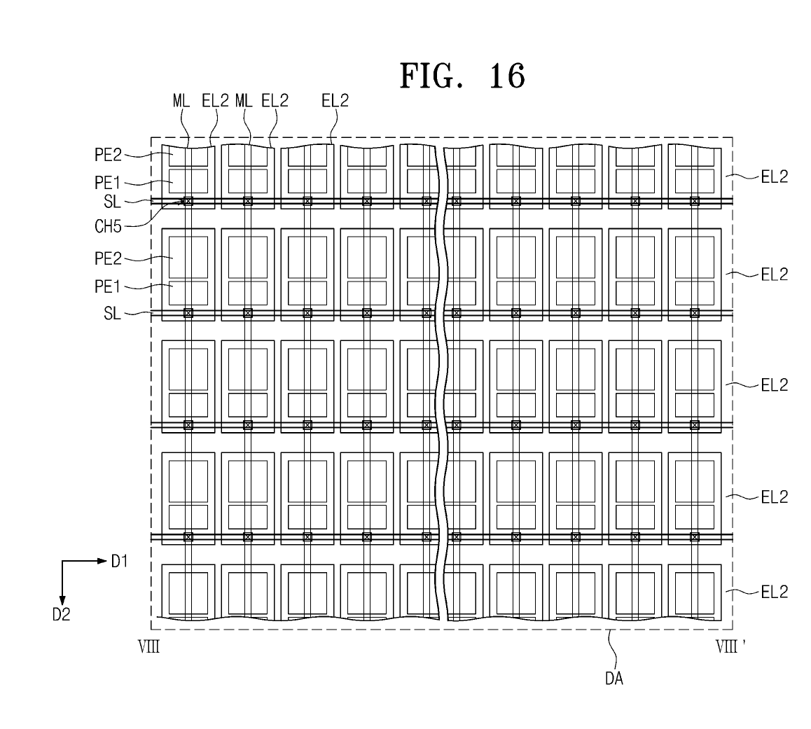

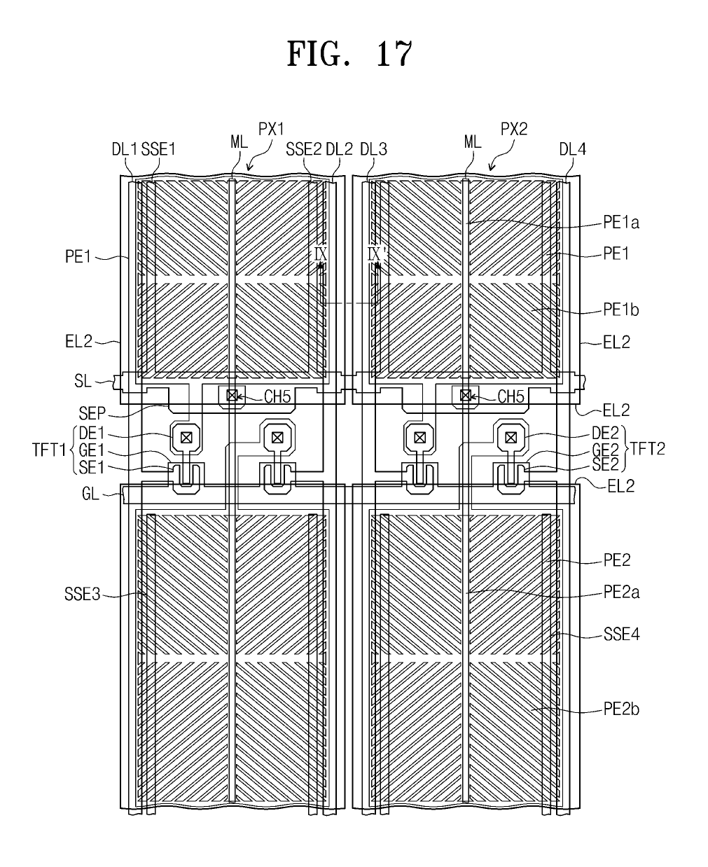

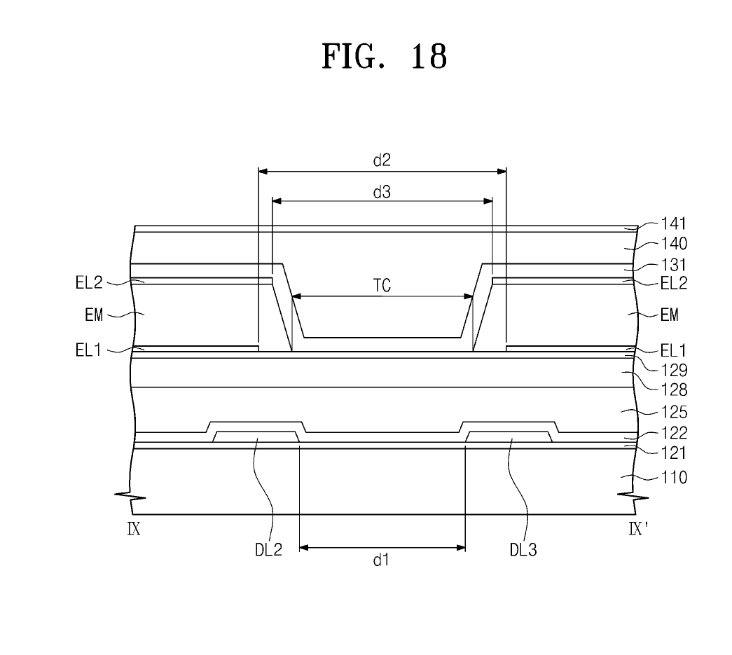

FIG. 16 is a plan view showing a common electrode according to another exemplary embodiment of the present disclosure, FIG. 17 is a plan view showing two pixels according to an exemplary embodiment of the present disclosure, and FIG. 18 is a cross-sectional view taken along a line IX-IX′ shown in FIG. 17.

Referring to FIG. 16, the common electrodes EL2 are arranged in the first and second directions D1 and D2 and spaced apart from each other by a predetermined distance. To this end, the common electrodes EL2 have a dot shape. In embodiments, the common electrodes EL2 make direct contact with the metal line ML and the storage line SL through the fifth contact hole CH5. The metal line ML electrically connects the common electrodes EL2 to each other, which are arranged in the second direction D2 and spaced apart from each other, and the storage line SL electrically connects the common electrodes EL1 to each other, which are arranged in the first direction D1 and spaced apart from each other.

Each of the common electrodes EL2 has a rectangular shape when viewed in a plan view. A distance between the common electrodes EL2 in the first direction D1 may be different from a distance between the common electrodes EL2 in the second direction D2.

Referring to FIG. 17, a first pixel PX1 is disposed between the first and second data lines DL1 and DL2 and a second pixel PX2 is disposed between the third and fourth data lines DL3 and DL4. The second and third data lines DL2 and DL3 are disposed between the first and second pixels PX 1 and PX2 and spaced apart from each other to be electrically insulated from each other.

The first and second sub-pixel electrodes PE1 and PE2 of the first pixel PX1 are partially overlapped with the first and second data lines DL1 and DL2. The first and second sub-pixel electrodes PE1 and PE2 of the second pixel PX2 are partially overlapped with the third and fourth data lines DL3 and DL4.

As shown in FIG. 18, when a distance between the second and third data lines DL2 and DL3 is referred to as “d1” and a distance between the first and second sub-pixel electrodes PE1 and PE2 of the first pixel PX1 is referred to as “d2”, the distance d1 is smaller than the distance d2. In addition, when the distance in the first direction D1 between the common electrodes EL2 is referred to as “d3”, the distance d3 is smaller than the distance d2.

As an example, the distance d3 in the first direction D1 between the common electrodes EL2 may be equal to or greater than a width of a trench TC disposed between the active cavity EM of the first pixel PX1 and the active cavity EM of the second pixel PX2.

When the common electrodes EL2 are removed from the trench TC, a coupling capacitor between the first and second sub-pixel electrodes PE1 and PE2 and the common electrodes EL2 or a coupling capacitor between the data lines DL1 to DL4 and the common electrodes EL2 may be reduced. Accordingly, defects caused by the coupling capacitors may be prevented.

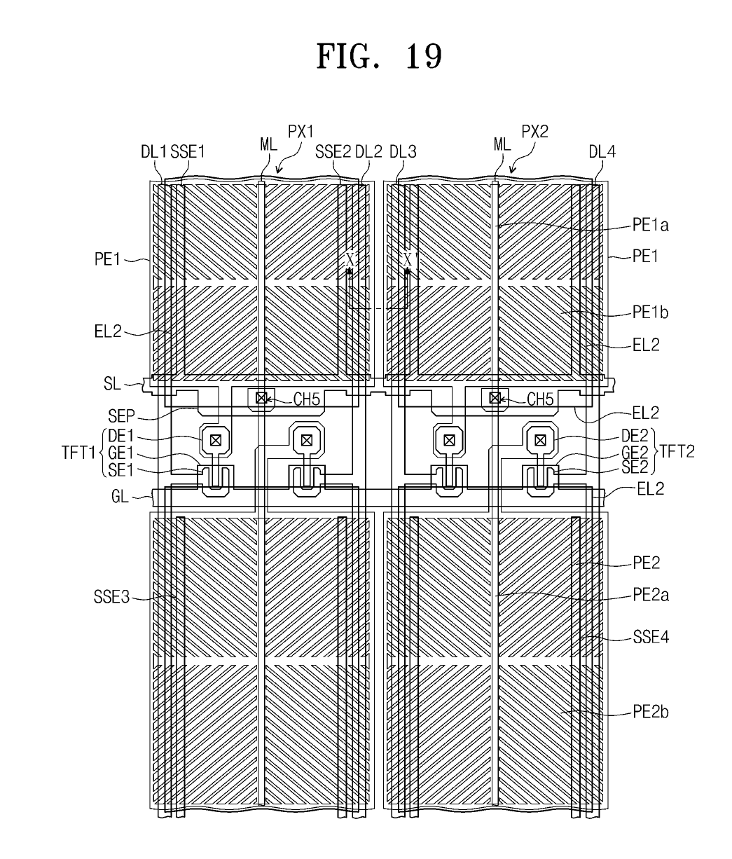

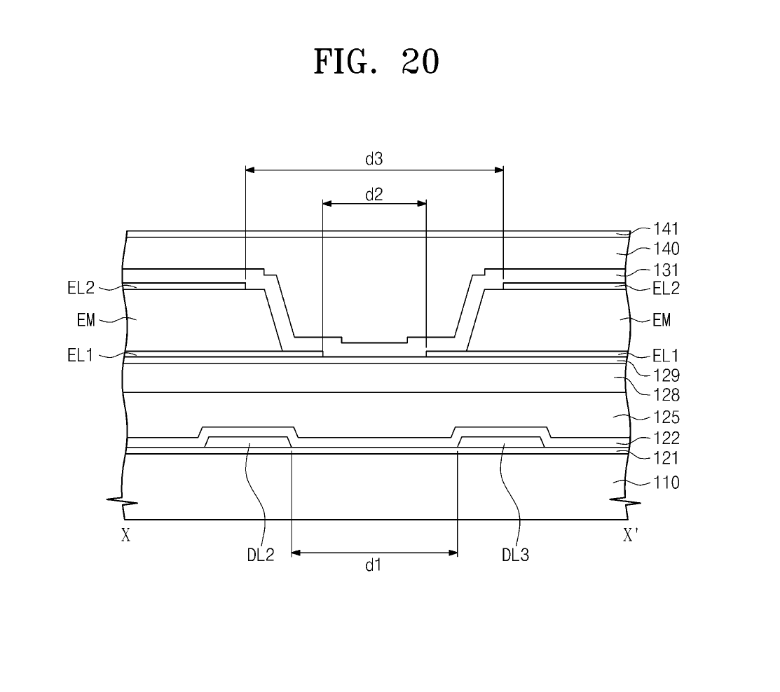

FIG. 19 is a plan view showing two pixels according to another exemplary embodiment of the present disclosure and FIG. 20 is a cross-sectional view taken along a line IX-IX′ shown in FIG. 19. In FIGS. 19 and 20, the same reference numerals denote the same elements in FIGS. 17 and 18, and thus detailed descriptions of the same elements will be omitted.

Hereinafter, for the convenience of explanation, the first and second sub-pixel electrodes PE1 and PE2 are referred to as the pixel electrode EL1.

Referring to FIGS. 19 and 20, when a distance between the second and third data lines DL2 and DL3 is referred to as “d1” and a distance between the first pixel electrode EL1 of the first pixel PX1 and the pixel electrode EL1 of the second pixel PX2 is referred to as “d2”, the distance d1 is greater than the distance d2. In addition, when the distance in the first direction D1 between the common electrodes EL2 is referred to as “d3”, the distance d3 is greater than the distance d2.

Therefore, the pixel electrode EL1 of the first pixel PX1 is fully overlapped with the first and second data lines DL1 and DL2 and the pixel electrode EL1 of the second pixel PX2 is fully overlapped with the third and fourth data lines DL3 and DL4.

As an example, the distance d3 in the first direction D1 between the common electrodes EL2 may be greater than a width of the trench TC disposed between the active cavity EM of the first pixel PX1 and the active cavity EM of the second pixel PX2.

Thus, ends of the common electrodes EL2 in the first direction D1 exist on the active cavity EM and the common electrodes EL2 do not exist between two active cavities EM adjacent to each other in the first direction D1.

In addition, the pixel electrode EL1 of the first pixel PX1 extends to the trenches TC disposed at left and right sides thereof and the pixel electrode EL1 of the second pixel PX2 extends to the trenches TC disposed at left and right sides thereof. Accordingly, the distance d2 between the pixel electrode EL1 of the first pixel PX1 and the pixel electrode EL1 of the second pixel PX2 may be smaller than the width of the trench TC.

When the common electrodes EL2 are removed from the trenches TC, the common electrodes EL2 may be prevented from being shorted with the pixel electrodes EL1 even though the pixel electrode EL1 extends to the trench TC.

In addition, the pixel electrode EL1 may be expanded to the trench TC, and thus the pixel electrode EL1 may be fully overlapped with corresponding data lines. In the full-overlap structure, a margin about the difference between the left and right coupling capacitors of the pixel electrode EL1 may be secured when compared to a half-overlap structure.

When the corresponding data lines are bent to or move to the pixel area in order to fully overlap the pixel electrode EL1 with the corresponding data lines, the transmittance of the pixel electrode EL1 is lowered.

However, when the pixel electrode EL1 is expanded to the trench TC to fully overlap with the corresponding data lines without moving to the pixel electrode, the transmittance of the pixel electrode EL1 may be prevented from being lowered.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A display apparatus comprising:
a base substrate that includes a display area and a peripheral area surrounding the display area;
an array of pixel electrodes formed over the display area of the base substrate;
an array of active cavities disposed over the array of pixel electrodes;
common electrodes opposing the array of pixel electrodes such that the array of active cavities are disposed between at least one common electrode of the common electrodes and the array of pixel electrodes; and
a metal line electrically connected with the at least one common electrodes in the display area.

2. The display apparatus of claim 1, wherein the pixel electrodes are arranged in rows extending in a first direction, and the common electrodes extend in the first direction such that the at least one common electrode overlaps two or more of the pixel electrodes and are arranged in a second direction different from the first direction.

3. The display apparatus of claim 2, wherein the metal line comprises a storage line extending in the first direction.

4. The display apparatus of claim 3, further comprising a bridge electrode to electrically connect the at least one common electrode and the storage line.

5. The display apparatus of claim 4, wherein a portion of the bridge electrode is disposed on a layer on which the pixel electrodes are disposed and electrically insulated from the pixel electrodes.

6. The display apparatus of claim 4, further comprising an extension part branched from the storage line to make direct contact with the bridge electrode.

7. The display apparatus of claim 6, further comprising an inter-insulating layer interposed between the pixel electrodes and the storage line, wherein the inter-insulating layer is provided with at least one contact hole formed therethrough to expose the extension part, and the bridge electrode directly contacts with the extension part through the contact hole and is connected to the at least one common electrode.

8. The display apparatus of claim 7, wherein the bridge electrode directly contacts with the at least one common electrode at a location outside the active cavity.

9. The display apparatus of claim 4, wherein the bridge electrode is provided in a plural number and the bridge electrodes are disposed to respectively correspond to the pixels.

10. The display apparatus of claim 4, wherein the bridge electrode is provided in a plural number and the bridge electrodes are disposed to correspond to blue pixels of the pixels.

11. The display apparatus of claim 3, further comprising an extension part branched from the storage line, wherein the at least one common electrode directly contact with the extension part at a location outside the active cavity.

12. The display apparatus of claim 11, further comprising inter-insulation layers sequentially stacked between the extension part and the at least one common electrode, wherein the inter-insulating layers are provided with one of the contact holes formed therethrough to expose the extension part, and the at least one common electrode directly contacts with the extension part through the contact hole.

13. The display apparatus of claim 3, further comprising a cover layer to define the active cavities, wherein the at least one common electrode are disposed on an inner surface of the cover layer.

14. The display apparatus of claim 2, further comprising a connection line disposed in the peripheral area, extending in the second direction, and electrically contacting with the at least one common electrode in the peripheral area.

15. The display apparatus of claim 1, wherein the pixel electrodes are arranged in rows extending in a first direction, and the metal line extends in a second direction which is different from the first direction to electrically connect the common electrodes to each other.

16. The display apparatus of claim 15, further comprising two data lines extending in the second direction, wherein each of the pixel electrodes arranged in a column extending in the second direction is disposed between the two data lines when viewed in a viewing direction perpendicular to a major surface of the base substrate, and the metal line is disposed between the two data lines to overlap a non-effective display area of the pixel electrode when viewed in the viewing direction.

17. The display apparatus of claim 16, wherein the metal line is disposed on a layer on which the data lines are disposed.

18. The display apparatus of claim 16, wherein each of the pixel electrodes comprises a trunk portion extending in the first and second directions to have a cross shape and a plurality of branch portions extending from the trunk portion in radial form, and the metal line is disposed to overlap a vertical portion of the trunk portion, which extends in the second direction.

19. The display apparatus of claim 15, further comprising a storage line extending in the first direction, wherein the metal line is electrically connected with the storage line.

20. The display apparatus of claim 19, wherein the storage line is disposed on a layer different from a layer on which the metal line is disposed, and the storage line is electrically connected with the metal line through a contact hole formed through an insulating layer between the storage line and the metal line.

21. The display apparatus of claim 19, wherein the common electrodes are arranged in the first and second directions in an array form and spaced apart from each other.

22. The display apparatus of claim 21, wherein the pixel electrodes are arranged in rows extending in a first direction, and a distance between two electrode segments adjacent to each other in the first direction is smaller than a distance between two pixel electrodes adjacent to each other in the first direction.

23. The display apparatus of claim 21, wherein the pixel electrodes are arranged in rows extending in a first direction, and a distance between two common electrodes adjacent to each other in the first direction is greater than a distance between two pixel electrodes adjacent to each other in the first direction.

24. The display apparatus of claim 23, further comprising two data lines respectively overlapping with two pixel electrodes adjacent to each other in the first direction, wherein the two data lines extend in the second direction.

25. The display apparatus of claim 24, wherein a distance between the two data lines is greater than a distance between two pixel electrodes adjacent to each other in the second direction.

26. The display apparatus of claim 1, wherein the active cavities contain a liquid crystal material.

27. The display apparatus of claim 1, wherein each of the pixels comprises a first sub-pixel area in which a first sub-pixel electrode is disposed and a second sub-pixel area in which a second sub-pixel electrode is disposed, the first and second sub-pixel areas are arranged in the second direction, and a non-effective area is disposed between the first and second sub-pixel areas.

28. The display apparatus of claim 27, wherein each of the common electrodes is disposed to correspond to the first and second sub-pixel areas, and an area between the common electrodes in the first direction corresponds to the non-effective area.

29. The display apparatus of claim 28, wherein an i-th (“i” is an integer number equal to or greater than 2) common electrode of the common electrodes is disposed to correspond to the second sub-pixel area of an (i−1)th pixel and the first sub-pixel area of an i-th pixel among two pixels successively arranged in the second direction.

30. A display apparatus comprising:
a base substrate that includes a display area and a peripheral area surrounding the display area;
an array pixel electrodes formed over the display area of the base substrate, the pixel electrodes arranged in rows and columns;
an array of active cavities, each of which is disposed over a corresponding one of the pixel electrodes;
an array of common electrodes arranged in the rows and the columns such that each of the common electrodes opposes one of the array of pixel electrodes, wherein the array of active cavities are disposed between the array of common electrodes and the array of pixel electrodes; and
a metal line electrically connected with two or more the common electrodes arranged in one of the rows or one of the columns.

31. The display apparatus of claim 30, wherein a distance between two common electrodes adjacent to each other in a first one of the rows is smaller than a distance between two pixel electrodes adjacent to each other in the first row.

32. The display apparatus of claim 30, wherein a distance between two common electrodes adjacent to each other in a first one of the rows is greater than a distance between two pixel electrodes adjacent to each other in the first row.

33. The display apparatus of claim 32, further comprising two data lines respectively overlapping with two pixel electrodes adjacent to each other in the first row, wherein the two data lines extend along the columns.

34. The display apparatus of claim 33, wherein a distance between the two data lines is greater than a distance between two pixel electrodes adjacent to each other in the first row.
